(19) United States
(12) Patent Application Publication
(10) Pub. No.: US 2023/0093219 A1
(43) Pub. Date: Mar. 23, 2023

(54) AUTOMOBILE WINDOW GLASS

(71) Applicant: AGC Inc., Tokyo (JP)

(72) Inventors: Koichi ICHIDA, Tokyo (JP); Yoshio KOSAKA, Tokyo (JP)

(73) Assignee: AGC Inc., Tokyo (JP)

(21) Appl. No.: 18/072,181

(22) Filed: Nov. 30, 2022

Related U.S. Application Data
(63) Continuation of application No. PCT/JP2021/020429, filed on May 28, 2021.

(30) Foreign Application Priority Data
Jun. 2, 2020 (JP) 2020-096182

(51) Int. Cl. B60S 1/02; H05B 3/84; B60R 1/20; B60R 1/00

(52) U.S. Cl. CPC B60S 1/026; H05B 3/84; B60R 1/20; B60R 1/001

(57) ABSTRACT

To provide an automobile window glass having an antifogging function, which can secure a favorable field of view of passengers in an automobile.

A windshield 10 according to an embodiment comprises an in-vehicle camera 20, a conductor 26, and wirings 36 and 40 to connect the conductor 26 and a battery 38. The conductor 26 has a heating portion 30, and has a resistor 50 between the heating portion 30 and the battery 38. The heating portion 30 heats an information transmitting/receiving region 28 which allows the in-vehicle camera 20 to take an image of the scenery outside the automobile through the windshield 10. The resistor 50 has a resistance corresponding to the resistance of a surplus wire at the heating portion.

### CROSS-REFERENCE TO RELATED APPLICATIONS

This application is a Bypass Continuation of PCT Application No. PCT/JP2021/020429, filed on May 28, 2021, which is based upon and claims the benefit of priority from Japanese Patent Application No. 2020-096182 filed on Jun. 2, 2020. The contents of those applications are incorporated herein by reference in their entireties.

### TECHNICAL FIELD

The present invention relates to an automobile window glass.

### BACKGROUND ART

Patent Document 1 proposes a windshield having an information acquisition device such as a camera to acquire information outside the vehicle.

According to the windshield disclosed in Patent Document 1, an information acquisition region which faces the camera and through which light is transmitted, is disposed adjacent to a shielding layer or so as to be surrounded by a shielding layer, and the information acquisition region is heated by an information acquisition region heating portion, to remove fogging of the information acquisition region.

Further, the information acquisition region heating portion disclosed in Patent Document 1 has a pair of bus bar portions and one heating wire to be connected to both the bus bar portions. The bus bar portions as a pair are disposed to be included in the shielding layer in the direction of the field of view, and the heating wire is disposed as bent at several positions with intervals so as to pass over the information acquisition region.

### PRIOR ART DOCUMENTS

### Patent Documents

Patent Document 1: JP-A-2017-216193

### DISCLOSURE OF INVENTION

### Technical Problem

By the way, an automobile window glass having an antifogging function (including snow melting function) as disclosed in Patent Document 1 is designed considering three conditions, that is the voltage, the power density and the heat generation region. Further, a heating wire which acts as the heating portion has a resistivity (adjustable resistance width) determined for each material employed. The heating wire is connected to the battery (power supply) of an automobile through a wiring, and a constant voltage (for example 11 to 14V) is applied from the battery. And, a means of adjusting the current which flows into the heating wire is required, and as an example of the means, it is considered to adjust the length of a heating wire disposed outside the heating region, that is a wire disposed between the bus bar portion and the heating region. That is, by adjusting the length of a heating wire disposed outside the heating region, the resistance of the heating wire itself is changed to adjust the current which flows into the heating wire.

However, if the length of the heating wire disposed outside the heating region is to be increased, the following problems may arise.

That is, in the vicinity of the information acquisition region on which the camera is disposed, a plurality of bonding regions to fix a plurality of brackets such as a camera bracket, an inner mirror base, and brackets for a distance sensor and a rain (raindrop) sensor to the windshield are present. Accordingly, an elongated heating wire disposed outside the heating region (hereinafter referred to as “surplus wire”) must be placed avoiding the bonding regions. Accordingly the area for placing the surplus wire relative to the windshield becomes inevitably large. And, when the area for placing the surplus wire is to be shielded by a shielding layer, the area of the shielding layer becomes large, and thus the field of view of passengers in the automobile becomes narrow.

Under these circumstances, the object of the present invention is to provide an automobile window glass having an antifogging function, by which a favorable field of view of passengers in an automobile can be secured.

### Solution to Problem

To achieve the above object, the present invention provides an automobile window glass configured to be attached to an automobile, which comprises an information communication device configured to be mounted on an automobile, a conductor, and a wiring configured to connect the conductor and a power supply disposed in the automobile,

wherein the conductor has a heating portion capable of heating an information transmitting/receiving region at which the information communication device is capable of transmitting and/or receiving information through the automobile window glass, and

which is configured such that a resistor is provided between the heating portion and the power supply.

### Advantageous Effects of Invention

According to the present invention, in an automobile window glass having an antifogging function, in a conductor having a heating portion capable of heating an information transmitting/receiving region at which an information communication device is capable of transmitting and/or receiving information through the automobile window glass, a surplus wire which corresponds to an elongated conductor (heating wire) disposed outside the information transmitting/receiving region, can be shortened, and the area for placing the surplus wire can be reduced, whereby a favorable field of view of passengers in the automobile can be secured.

### BRIEF DESCRIPTION OF DRAWINGS

FIG. 1 is a front view illustrating a windshield according to an embodiment of the present invention as viewed from the automobile interior side.

FIG. 2 is a schematic cross sectional view illustrating the windshield along the line 2-2 in FIG. 1.

FIG. 3 is a front view illustrating an enlarged upper center portion of the windshield shown in FIG. 1.

FIG. 4 is an electrical circuit diagram illustrating a first example for arrangement of a resistor in the present embodiment.

FIG. 5 is a schematic diagram corresponding to the electrical circuit diagram shown in FIG. 4.

FIG. 6 is a plan view illustrating an example of configuration of a first wiring in the first example for arrangement of a resistor.

FIG. 7 is a schematic diagram illustrating a second example for arrangement of a resistor in the present embodiment.

FIG. 8 is a schematic diagram illustrating a third example for arrangement of a resistor in the present embodiment.

FIG. 9 is an electrical circuit diagram illustrating a fourth example for arrangement of a resistor in the present embodiment.

FIG. 10 is a schematic diagram corresponding to the electrical circuit diagram shown in FIG. 9.

FIG. 11 is a diagram illustrating a state where a resistor is connected in parallel between a heating portion and a battery in the present embodiment.

FIG. 12 is a view illustrating a substantial part of a windshield provided with a heating portion having a surplus wire.

FIG. 13 is an electrical circuit diagram illustrating the windshield shown in FIG. 12.

FIGS. 14A and 14B are diagrams illustrating a first example of a sheet-formed heating element.

FIGS. 15A and 15B are diagrams illustrating a second example of a sheet-formed heating element.

### DESCRIPTION OF EMBODIMENTS

The automobile window glass according to an embodiment of the present invention comprises an information communication device, a conductor, and a wiring connecting the conductor and a power supply. The conductor has a heating portion capable of heating an information transmitting/receiving region. Between the heating portion and the power supply, a resistor is provided.

Further, the present embodiment will be described with reference to a windshield configured to a laminated glass, as an example of the automobile window glass, however, the present invention is by no means restricted thereto. For example, the present invention is applicable to other automobile window glasses such as a rear glass, a door glass and a roof glass configured to a single glass plate.

Now, the windshield according to an embodiment of the present invention will be described with reference to the drawings.

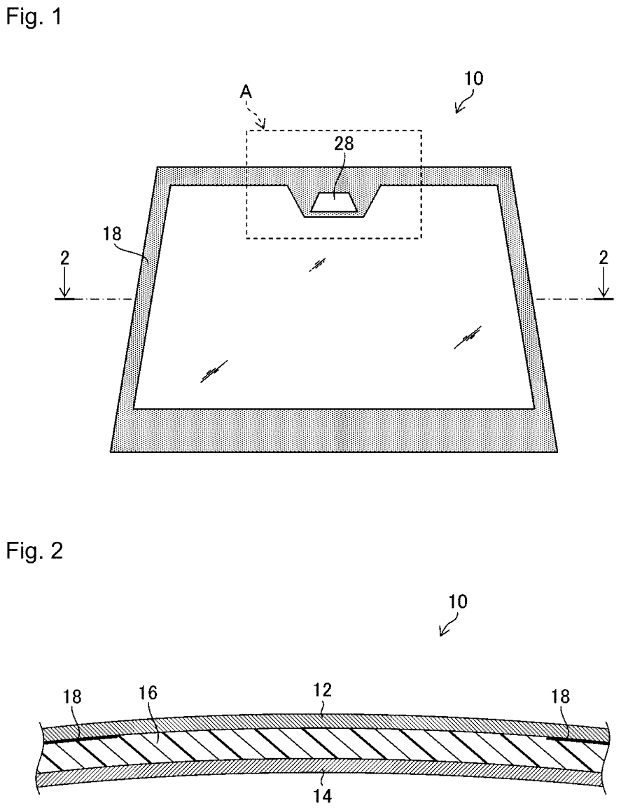

FIG. 1 is a front view illustrating a windshield according to an embodiment as viewed from the automobile interior side. Further, FIG. 2 is a schematic cross sectional view illustrating the windshield 10 along the line 2-2 in FIG. 1.

The windshield 10 shown in FIGS. 1 and 2 is a laminated glass having a first glass plate (hereinafter referred to as “glass plate”) 12 located on the automobile exterior side when attached to an automobile vehicle and a second glass plate (hereinafter referred to as “glass plate”) 14 located on the automobile interior side, facing each other. Further, an interlayer 16 is disposed between the glass plate 12 and the glass plate 14, and by this interlayer 16, the glass plate 12 and the glass plate 14 are bonded.

As the glass plates 12 and 14, for example, inorganic glass such as soda lime glass, aluminosilicate glass, borosilicate glass, alkali free glass or quartz glass, or organic glass may be used. The glass plate 12 disposed on the automobile exterior side is preferably made of inorganic glass from the viewpoint of scratch resistance, preferably soda lime glass from the viewpoint of forming property. In a case where the glass plates 12 and 14 are made of soda lime glass, clear glass, green glass containing iron contents in a predetermined amount or more, or UV cut green glass may suitably be used. In a case where the glass plates 12 and 14 are made of inorganic glass, the glass plates 12 and 14 may be produced, for example, by float process. On the other hand, as the material of the organic glass, a transparent resin such as a polycarbonate, an acrylic resin such as polymethyl methacrylate, a polyvinyl chloride or polystyrene may be mentioned.

The plate thickness of the glass plate 12 is preferably 1.1 mm or more and 3 mm or less. When the plate thickness of the glass plate 12 is 1.1 mm or more, strength such as flying stone resistance can be secured, and when it is 3 mm or less, weight saving of the windshield 10 will be achieved, whereby mileage of the automobile will be improved. The plate thickness of the glass plate 12 is more preferably 1.8 mm or more and 2.8 mm or less at the thinnest portion, further preferably 1.8 mm or more and 2.6 mm or less, still more preferably 1.8 mm or more and 2.2 mm or less, even more preferably 1.8 mm or more and 2.0 mm or less.

The plate thickness of the glass plate 14 is preferably 0.3 mm or more and 2.3 mm or less. When the plate thickness of the glass plate 14 is 0.3 mm or more, good handling efficiency will be obtained, and when it is 2.3 mm or less, weight waving of the windshield 10 will be achieved, whereby mileage of the automobile will be improved.

The total thickness of the windshield 10 (laminated glass) is preferably 2.8 mm or more and 10 mm or less. When the total thickness of the windshield 10 is 2.8 mm or more, sufficient stiffness will be secured. Further, when the total thickness of the windshield 10 is 10 mm or less, sufficient transmittance will be obtained and at the same time, haze can be reduced. The plate thicknesses of the glass plates 12 and 14 may be the same or different.

Either one or both of the glass plates 12 and 14 may have a wedge cross section such that the plate thickness increases from the lower edge toward the upper edge of the windshield 10, in a state where the windshield 10 is attached to an automobile.

In a case where the windshield 10 is curved, the glass plates 12 and 14 are bent after formation by e.g. float process and before bonding by the interlayer 16. Bending is carried out by heating and softening the glass plates 12 and 14. Specifically, the glass plates 12 and 14 may be bent, after formation by float process, by gravity forming, pressing or the like. The heating temperature for the glass plates 12 and 14 at the time of bending is from 550 to 700° C., which is the vicinity of the softening temperature.

The windshield 10 may be single curved, that is curved only one direction, for example, when attached to an opening of an automobile, in the longitudinal direction or in the vertical direction of the automobile. Further, the windshield 10 may be double curved that is curved in the longitudinal direction and in the vertical direction of the automobile. The radii of curvature of the glass plates 12 and 14 in the windshield 10 may be the same or different. The radii of curvature of the glass plates 12 and 14 may be from 1,000 to 100,000 mm.

The glass plates 12 and 14 may be either non-tempered glass or tempered glass. Non-tempered glass is one obtained by forming molten glass into a plate, followed by annealing. Tempered glass may be either physically tempered glass (such as air-tempered glass) or chemically tempered glass. In a case of physically tempered glass, the glass surface may be tempered by forming a compression stress layer on the glass surface by a temperature difference between the glass surface and the glass interior e.g. by operation other than annealing, such as quenching a glass plate uniformly heated in bending, from the vicinity of the softening point. In a case of chemically tempered glass, the glass surface may be tempered, after bending, by forming compression stress on the glass surface e.g. by ion exchange method. Otherwise, glass which absorbs ultraviolet rays or infrared rays may be used. Further, the glass plates 12 and 14 are preferably transparent, but may be glass plates colored to such an extent not to impair transparency. In such a case, the visible light transmittance of the windshield 10 is preferably 70% or more.

The windshield 10 has a shielding layer formed on its periphery. The shielding layer 18 may be formed, for example, by applying a ceramic color paste containing fusible glass frit containing a black pigment on the glass plate e.g. by screen printing, followed by firing, but its production is not limited thereto. The shielding layer 18 may be formed, for example, by applying an organic ink containing a black or deep color pigment on the glass plate e.g. by screen printing, followed by drying. The shielding layer 18 may be a colored interlayer having light shielding property, a colored film, or a combination of a colored interlayer and a colored ceramic layer. The colored film may be united with e.g. an infrared reflecting film. By the shielding layer 18, a resin such as a urethan to hold the periphery of the windshield 10 on the vehicle body can be prevented from being deteriorated by ultraviolet rays.

In FIG. 2, a windshield 10 having a shielding layer 18 formed on the surface on the automobile interior side of the glass plate 12 is shown, however, the shielding layer 18 may be formed on at least one of the glass plates 12 and 14. Further, the shielding layer 18 is formed preferably on the surface on the automobile interior side of the glass plate 12 or 14. Further, the shielding layer 18 may be provided on the entire periphery of the windshield 10 or may be formed on a part of the periphery of the windshield 10.

For the interlayer 13, a thermoplastic resin is used in many cases, and for example, a thermoplastic resin which has been used for such a type of application, such as a plasticized polyvinyl acetal resin, a plasticized polyvinyl chloride resin, a saturated polyester resin, a plasticized saturated polyester resin, a polyurethane resin, a plasticized polyurethane resin, an ethylene/vinyl acetate copolymer resin (hereinafter sometimes referred to as “EVA”) or an ethylene/ethyl acrylate copolymer resin may be mentioned.

Among them, with a view to obtaining one excellent in balance of various performances such as transparency, weather resistance, strength, adhesion, penetration resistance, impact energy absorption property, moisture resistance, heat shielding property and sound insulating property, a plasticized polyvinyl acetal resin is suitably used. Such a thermoplastic resin may be used alone or in combination of two or more. “Plasticized” in the plasticized polyvinyl acetal resin means being plasticized by addition of a plasticizer. The same applies to the other plasticized resins.

The polyvinyl acetal resin may be a polyvinyl formal resin obtained by reacting polyvinyl alcohol (hereinafter sometimes referred to as “PVA”) and formaldehyde, a narrowly defined polyvinyl acetal resin obtained by reacting PVA and acetaldehyde, a polyvinyl butyral resin obtained by reacting PVA and n-butyraldehyde (hereinafter sometimes referred to as “PVB”), or the like. Particularly in view of excellent balance of various performances such as transparency, weather resistance, strength, adhesion, penetration resistance, impact energy absorbing property, moisture resistance, heat shielding property and sound insulating property, PVB is suitable. Such a polyvinyl acetal resin may be used alone or in combination of two or more. However, the material forming the interlayer 16 is not limited to a thermoplastic resin.

The glass plates 12 and 14 are bonded by heat bonding at a temperature at which the interlayer 16 is softened. For example, in a case where a PVB film is used as the interlayer 16, an autoclave is used, and the heating temperature is preferably at a level of 130° C. and the pressure applied is preferably at a level of 1 MPa. Further, in a case where an EVA film is used, the heating temperature is preferably at a level of 90° C., and the pressure applied is preferably at a level of 1 MPa. The method for producing a laminated glass using the above film is well known, and its description is omitted.

The thickness of the interlayer 16 is preferably 0.5 mm or more and 3.0 mm or less. When the thickness of the interlayer 16 is 0.5 mm or more, penetration resistance required for the windshield 10 will be secured. Further, when the thickness of the interlayer 16 is 3 mm or less, weight saving will be achieved, and good handling efficiency will be obtained.

The interlayer 16 may have a region having a sound shielding function, an infrared shielding function, an ultraviolet shielding function, a shade band (a function to lower the visible light transmittance), etc. Further, the interlayer 16 may be configured to two or more layers. For example, in a case where the interlayer 16 is configured to three layers and the hardness of the center layer is lower than the hardnesses of the layers on both sides, the sound insulating property will be improved. Further, the interlayer 16 may have a wedge section such that the film thickness increases from the lower edge toward the upper edge of the windshield, in a state where the windshield 10 is attached to an automobile.

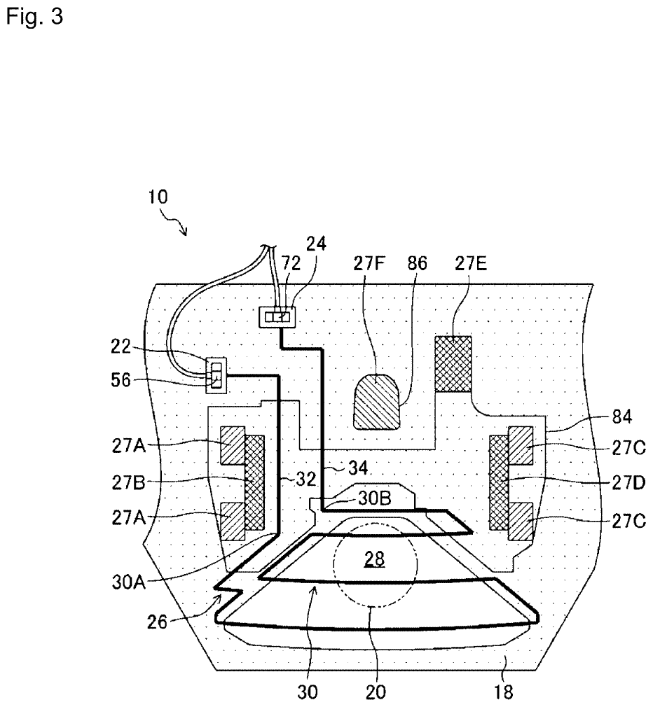

FIG. 3 is a front view illustrating an enlarged upper center portion (portion A) of the windshield 10 shown in FIG. 1. In FIG. 3, a pair of bus bars 22 and 24, a part of a conductor 26 shown by a bold line, and rectangular bonding regions 27A, 27B, 27C, 27D, 27E and 27F shown in a mesh or by hatching, are shown on the shielding layer 18. The bus bars 22 and 24, the conductor 26 and the bonding regions 27A to 27F will be described later. For such bonding regions, different adhesives may be used. For example, for the bonding regions 27A, 27C, 27D and 27E shown by hatching, a chief adhesive (a known acrylic resin, urethane resin or epoxy resin-based adhesive, etc.) may be used, and for the bonding regions 27B and 27E shown in a mesh, a double-sided tape (or hot melt adhesive) for temporary fixing may be used for temporary fixing so as to fix members until the chief adhesive is cured and to secure the adhesive layer (thickness) of the chief adhesive.

As shown in FIG. 3, at the upper center of the windshield 10, which will not impair the field of view of passengers in the automobile, an in-vehicle camera 20 shown by a double-dotted line in FIG. 3 is mounted on the automobile interior side of the windshield 10, and on a region facing the in-vehicle camera 20, an information transmitting/receiving region 28 is provided. The information transmitting/receiving region 28 is configured to opening a part of the shielding layer 18 for example into a trapezoid, whereby the in-vehicle camera 20 can take an image of the front view of the automobile through the transparent information transmitting/receiving region 28. The in-vehicle camera 20 is an example of the information communication device of the present invention. That is, the information communication device can transmit and/or receive information through the windshield 10. In the embodiment shown in the drawing, the entire periphery of the information transmitting/receiving region 28 is configured as surrounded by the shielding layer 18, however, at least a part may be surrounded by the shielding layer 18. The visible light transmittance of the information transmitting/receiving region 28 is preferably 70% or more so that a favorable image can be taken by the in-vehicle camera 20.

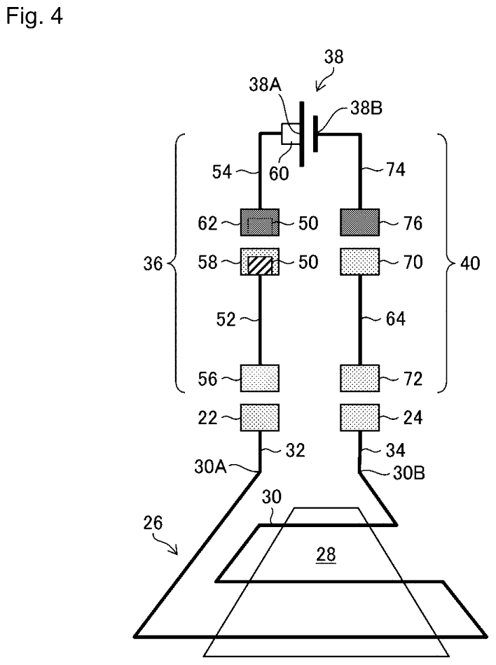

FIG. 4 is an electrical circuit diagram illustrating supply of a current to the conductor 26.

As shown in FIG. 4, the conductor 26 has a heating portion 30 capable of heating the information transmitting/receiving region 28, a lead portion 32 to connect a first end 30A of the heating portion 30 and a bus bar 22 on the positive side, and a lead portion 34 to connect a second end 30B of the heating portion 30 and a bus bar 24 on the negative side. The bus bars 22 and 24 function as the power feeding portion of the present invention. The conductor 26 is a conductor wire as an example, and the heating portion 30 is a heating wire as an example. As a material constituting the conductor 26, in a case where the conductor 26 is a conductor wire, it may be formed by firing a conductive silver paste containing a silver powder and gras frit. The conductive silver paste may, for example, be one containing as solid content from 60 to 90% of a silver powder, from 1 to 10% of a glass powder and from 5 to 30% of an inorganic additive, and an organic binder and an organic solvent. The average particle size of the silver powder contained in the silver paste is preferably from 0.1 to 10 μm. The thickness of the conductor 26 is preferably from 5 to 20 μm. Further, in a case where the conductor 26 is a conductor wire, the width of the conductor wire is preferably 0.1 mm or more and 0.5 mm or less, more preferably from 0.15 to 0.35 mm. The lead portions 32 and 34 are, as an example, lead wires.

The bus bars 22 and 24 and the conductor 26 are formed on the surface on the automobile interior side of the windshield 10. For example, they are formed on the surface on the automobile interior side of the glass plate 12 or on the surface on the automobile interior side of the glass plate 14.

The heating portion 30 is bent in a horizontal direction at several portions at intervals in the vertical direction, whereby it crosses the information transmitting/receiving region 28 in a horizontal direction. The heating portion 30 has, as described above, a function to heat the information transmitting/receiving region 28, and the lead portions 32 and 34 are portions to supply a current to the heating portion 30 and do not contribute to heating of the information transmitting/receiving region 28. The lead portions 32 and 34 are formed from the same conductive silver paste as for the heating portion 30.

Now, the bus bars 22 and 24 will be described. The bus bar 22 is connected to a positive terminal 38A of the battery 38 through the wiring 36, and the bus bar 24 is connected to a negative terminal 38B of the battery 38 through the wiring 40. The battery 38 functions as the power supply of the present invention.

Accordingly, the windshield 10 according to the embodiment has the in-vehicle camera 20 mounted on the automobile-interior side, the conductor 26, and the wirings 36 and 40 to connect the conductor 26 and the battery 38. And, the conductor 26 has the heating portion 30 to heat the information transmitting/receiving region 28 to allow the in-vehicle camera 20 to take an image of the scenery outside the automobile through the windshield 10.

According to the windshield 10 configured above, upon supply of the current from the battery 38 to the heating portion 30 through the wirings 36 and 40, etc., the heating portion 30 generates heat, the heat generated by the heating portion 30 warms the information transmitting/receiving region 28 of the windshield 10 and removes fogging or freezing on the surface of the information transmitting/receiving region 28. By this heating portion 30, a favorable image by the in-vehicle camera 20 is secured.

Here, the windshield 10 according the embodiment has a resistor 50 (see FIGS. 4 to 5, 7 to 10) between the heating portion 30 and the battery 38. The resistor 50 has a resistance corresponding to the resistance of the above described “surplus wire of the heating portion disposed outside the information transmitting/receiving region 28”. That is, in the windshield 10 according the embodiment, in adjustment of the current which flows into the heating portion 30, adjustment of the current is carried out not by adding the surplus wire to the heating portion 30 disposed outside the information transmitting/receiving region 28, but by providing the resistor 50. Thus, the surplus wire in the heating portion 30 disposed outside the information transmitting/receiving region 28 can be shortened, and the increase of the area of the shielding layer 18 resulting from the surplus wire can be suppressed. Accordingly, by the windshield 10 according the embodiment having an antifogging function, a favorable field of view of passengers in the automobile can be secured. Further, in a case where the surplus wire disposed outside the information transmitting/receiving region 28 generates heat in the same manner as the heating portion 30, the generated heat does not heat the information transmitting/receiving region 28 and in addition, unnecessary local heating of the windshield 10 and heating of the information communication device itself such as the in-vehicle camera 20 and the bracket to fix the information communication device to the windshield 10, can be prevented.

Now, examples for arrangement of the resistor 50 will be described. In the following examples, the resistor 50 is provided on the wiring 36 side, however, the resistor 50 may be provided on the wiring 40 side.

### First Example

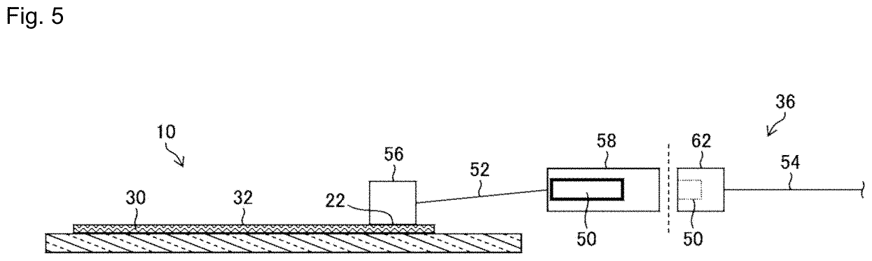

FIG. 4 is an electrical circuit diagram illustrating a first example for arrangement of the resistor 50, and FIG. 5 is a schematic diagram corresponding to the electrical circuit diagram shown in FIG. 4.

As shown in FIGS. 4 and 5, the wiring 36 has a first wiring 52 and a second wiring 54. On a first end of the first wiring 52, a terminal 56 to be electrically connected to the bus bar 22 is provided, and on a second end of the first wiring 52, a first connector 58 is provided. Further, on a first end of the second wiring 54, a connecting portion 60 to be electrically connected to the battery 38 is provided, and on a second end of the second wiring 54, a second connector 62 to be electrically connected to the first connector 58 is provided. And, the resistor 50 is disposed in the first connector 58.

As described above, by disposing the resistor 50 in the first connector 58, the current which flows into the heating portion 30 can be adjusted. Further, the surplus wire disposed outside the information transmitting/receiving region 28 in the heating portion 30 can be shortened, whereby the increase of the area of the shielding layer 18 resulting from the surplus wire can be suppressed. Further, since it is not necessary to connect the resistor 50 to the windshield 10, the current can be adjusted only by connecting the first connector 58 having the resistor 50 disposed therein and the second connector 62, and operation of connection to the battery 38 can be simplified. Accordingly, by employing the first example, a windshield 10 which can secure a favorable field of view of passengers in the automobile can be provided.

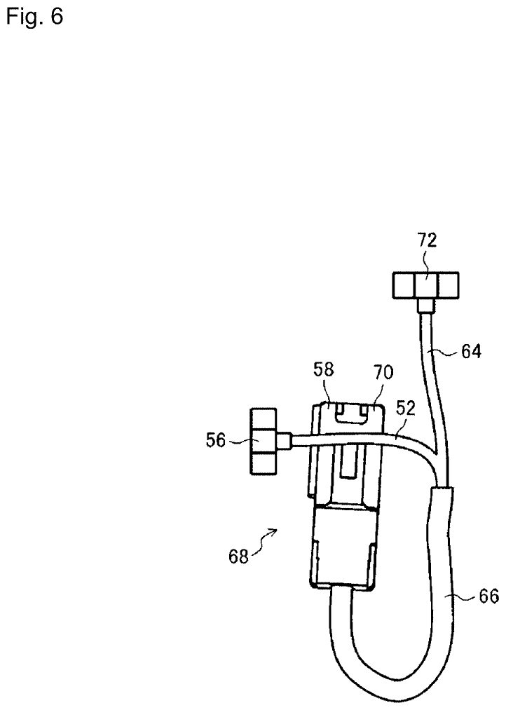

Now, an example of the first wiring 52 will be described. FIG. 6 is a plan view illustrating the first wiring 52.

As shown in FIG. 6, in order that the first wiring 52 is combined with a first wiring 64 on the wiring 40 (see FIG. 4) side, the two first wirings 52 and 64 are bundled by a cable band 66 and connected to a harness 68. To the harness 68, the first connector 58 and a first connector 70 on the wiring 40 (see FIG. 4) side. Further, to the first end of the first wiring 64, a terminal 72 to be electrically connected to the bus bar 24 (see FIG. 4) is provided. The first wirings 52 and 64 shown in FIG. 6 are members connected on the windshield 10 side and integrated with the windshield 10.

The first example shown in FIGS. 4 and 5 is an example in which the resistor 50 is disposed in the first connector 58, however, the resistor 50 may be disposed in the second connector 62 as shown in a mesh in FIG. 4. That is, the resistor 50 is disposed in at least one of the first connector 58 and the second connector 62.

Further, in FIG. 4, the reference symbol 74 indicates a second wiring on the wiring 40 side, and the reference symbol 76 indicates a second connector on the wiring 40 side.

### Second Example

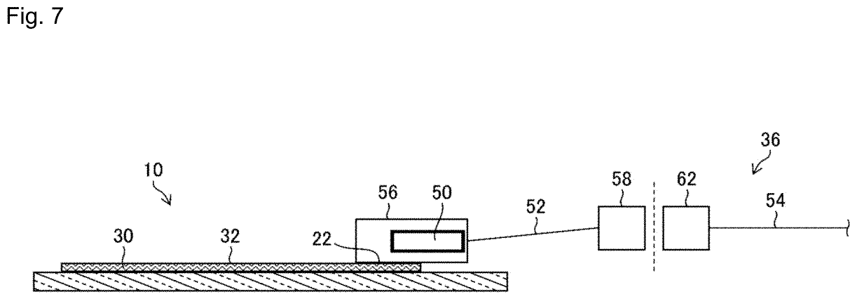

FIG. 7 is a schematic diagram illustrating a second example for arrangement of the resistor 50. The identical or similar members to those in the first example shown in FIGS. 4 and 5 are described with the same symbols.

As shown in FIG. 7, the wiring 36 has a terminal 56 as a connector to be electrically connected to the bus bar 22 at a first end and a connecting portion 60 (see FIG. 4) to be electrically connected to the battery 38 (see FIG. 4) at a second end. The resistor 50 is disposed in the terminal 56.

As described above, by disposing the resistor 50 in the terminal 56, the current which flows into the heating portion 30 can be adjusted. Further, the surplus wire disposed outside the information transmitting/receiving region 28 in the heating portion 30 can be shortened, whereby the increase of the area of the shielding layer 18 resulting from the surplus wire can be suppressed. Further, since it is not necessary to connect the resistor 50 to the windshield 10, the current can be adjusted only by connecting the terminal 56 having the resistor 50 disposed therein to the bus bar 22, and the operation of connection to the battery 38 can be simplified. Accordingly, by employing the second example, a windshield 10 which can secure a favorable field of view of passengers in the automobile can be provided.

The second example shown in FIG. 7 is an example in which the wiring 36 having the first wiring 52 and the second wiring 54 is employed, however, the wiring 36 may have only one wiring.

### Third Example

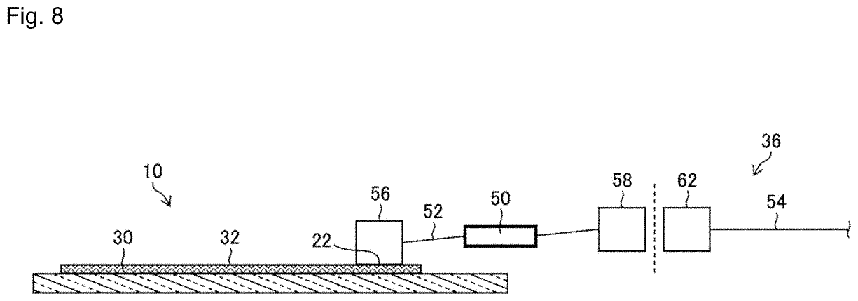

FIG. 8 is a schematic diagram illustrating a third example for arrangement of the resistor 50. The identical or similar members to those in the first example shown in FIGS. 4 and 5 are described with the same symbols.

As shown in FIG. 8, the resistor 50 is disposed on the first wiring 52.

As described above, by disposing the resistor 50 on the first wiring 52 also, in the same manner as in the first example and the second example, a windshield 10 which can secure a favorable field of view of passengers in the automobile can be provided. The same applies to a case where the resistor 50 is disposed on the second wiring 54. Further, the third example shown in FIG. 8 is an example in which the wiring 36 having the first wiring 52 and the second wiring 54 is employed, however, the wiring 36 may have only one wiring.

### Fourth Example

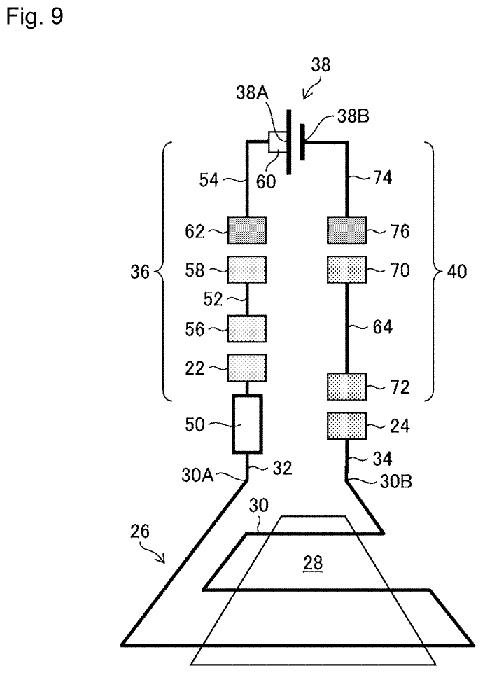

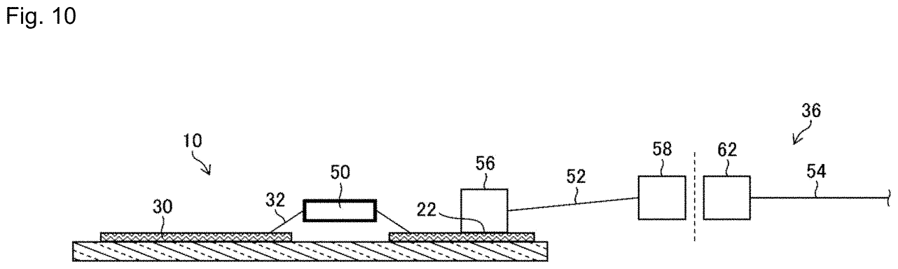

FIG. 9 is an electrical circuit diagram illustrating a fourth example for arrangement of the resistor 50, and FIG. 10 is a schematic diagram corresponding to the electrical circuit diagram shown in FIG. 9.

As shown in FIGS. 9 and 10, the resistor 50 is disposed between the heating portion 30 and the bus bar 22. Specifically, the resistor 50 is disposed on a part of the lead portion 32. In a case where the resistor 50 is disposed on the surface of the windshield 10, the lead portion 32 and the resistor 50 are connected preferably by lead free solder. Further, in a case where the resistor 50 is disposed on the surface of the windshield 10, the resistor 50 is covered preferably by a silicone resin, an epoxy resin, a urethane resin or the like so that moisture, etc. will not be brought into contact with the resistor 50.

As described above, by disposing the resistor 50 on the lead portion 32 also, in the same manner as in the first to third examples, a windshield 10 which can secure a favorable field of view of passengers in the automobile can be provided. Further, the fourth example shown in FIGS. 9 and 10 is an example in which the wiring 36 having the first wiring 52 and the second wiring 54 is employed, however, the wiring 36 may have only one wiring.

The examples for arrangement of the resistor 50 are described above, however, the present invention is not limited to such examples for arrangement. That is, the resistor 50 may be disposed between the heating portion 30 and the battery 38.

The resistor 50 shown in the first to fourth examples may be a fixed resistor or may be a semi-fixed resistor or a variable resistor. However, a fixed resistor with no variation is preferable to a semi-fixed resistor or a variable resistor by which the resistance may change due to vibration of the automobile. The fixed resistor may be any fixed resistor such as a lead type, a surface mount type or a cement resistor.

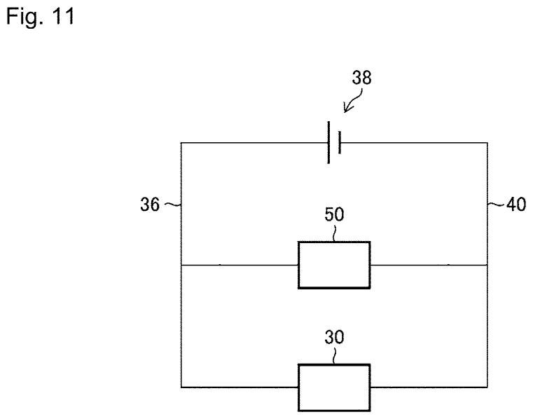

Further, the example for arrangement of the resistor 50 shown in the first to fourth examples is an example in which the resistor 50 is connected in series between the heating portion 30 and battery 38, however, as shown in FIG. 11, the resistor 50 may be connected in parallel between the heating portion 30 and the battery 38.

Now, the windshield 10 according the embodiment shown in FIGS. 3 and 4, and a windshield provided with a heating portion having a surplus wire, are compared.

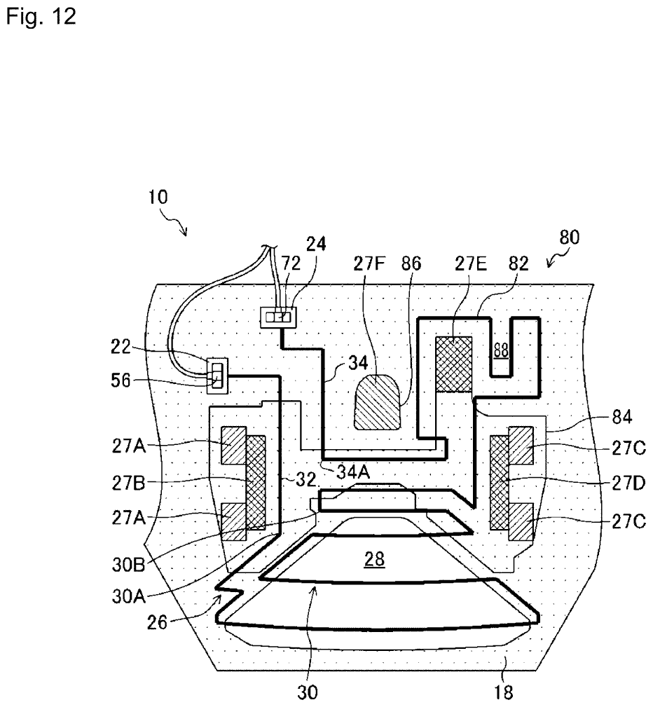

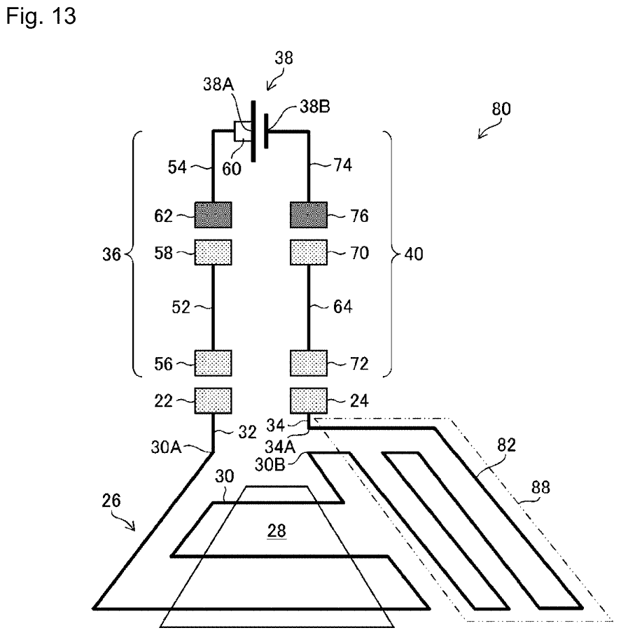

FIG. 12 is a view illustrating a substantial part of a windshield 80 provided with a heating portion 30 having a surplus wire 82 disposed outside an information transmitting/receiving region 28. FIG. 13 is an electrical circuit diagram illustrating the windshield 80 shown in FIG. 12. In explanation of the windshield 80 shown in FIGS. 12 and 13, the identical or similar members to those in the windshield 10 according to the embodiment shown in FIGS. 3 and 4 are described with the same symbols.

First, bonding regions 27A to 27F shown in FIGS. 3 and 12 will be described. Among these bonding regions, the bonding regions 27A to 27E are regions formed to bond the camera bracket 84 shown by a thin line in FIGS. 3 and 12 to the windshield 10 (glass plate 14). Further, the bonding region 27F is a region formed to bond an inner mirror base 86 shown by a thin line in FIGS. 3 and 12 to the windshield 10 (glass plate 14).

Now, the surplus wire 82 shown in FIG. 12 will be described with reference to the heating portion 30 in FIG. 3. The surplus wire 82 is disposed to avoid the bonding regions 27C, 27D, 27E and 27F and is connected to a second end 30B of the heating portion 30 and a first end 34A of the lead portion 34. Thus, as shown in FIGS. 12 and 13, the area 88 for placing the surplus wire 82 relative to the windshield 80 becomes inevitably large, and when the area 88 is to be shielded by a shielding layer 18, the area of the shielding layer 18 becomes large, and thus the field of view of passengers in the automobile becomes narrow.

As compared with such a windshield 80, the windshield 10 according the embodiment shown in FIG. 3 has the resistor 50 (see FIGS. 4 to 10) having a resistance corresponding to the resistance of the surplus wire 82 disposed between the heating portion 30 and the battery 38, whereby the increase of the area of the shielding layer 18 resulting from the surplus wire 82 can be suppressed, and thus a windshield 10 which can secure a favorable field of view of passengers in the automobile can be provided.

Now, a modified example of the conductor will be described.

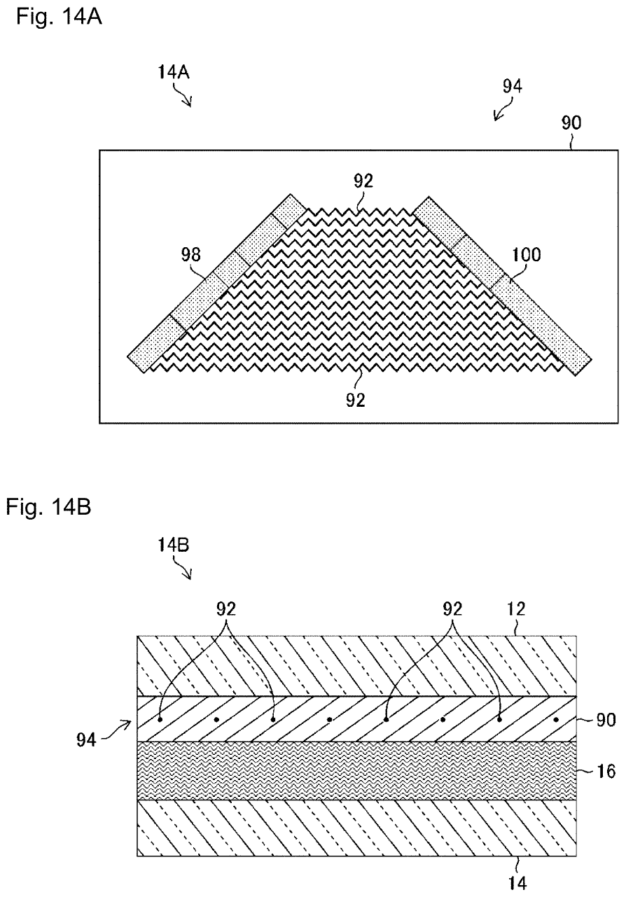

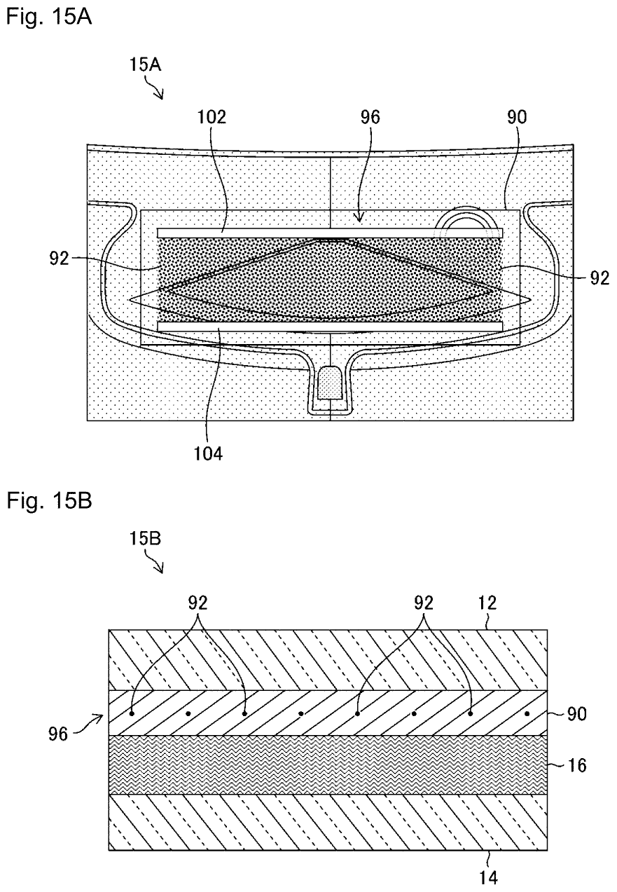

The conductor 26 shown in FIG. 3 is a conductor wire and is formed, for example, by printing a conductive silver paste on the glass plate 12 or the glass plate 14. As a modified example, as shown in a first example shown in FIGS. 14A and 14B and a second example shown in FIGS. 15A and 15B, sheet-formed heating elements 94 and 96 having a plurality of heating wires 92 provided on a sheet-formed member 90 may be employed. In the first example shown in FIGS. 14A and 14B and the second example shown in FIGS. 15A and 15B also, by properly employing the example for arrangement of the resistor shown in the first to fourth examples, the surplus wire disposed outside the information transmitting/receiving region 28 in the heating portion 30 can be shortened.

### <Sheet-Formed Heating Element 94>

As shown in the front view illustrating the sheet-formed heating element 94 shown in FIG. 14A, on the left and right sides of the sheet-formed member 90, bus bars 98 and 100 are provided, and the plurality of the heating wires 92 connected to the bus bars 98 and 100 are placed along the horizontal direction at intervals in the vertical direction. The heating wires 92 are made of, for example, copper.

### <Sheet-Formed Heating Element 96>

As shown in the front view of the sheet-formed heating element 96 shown in FIG. 15A, on the top and bottom sides of the sheet-formed member 90, bus bars 102 and 104 are placed along the horizontal direction, and a plurality of heating wires 92 connected to the bus bars 102 and 104 are placed along the vertical direction at intervals in the horizontal direction. The plurality of heating wires 92 connected to the bus bars 102 and 104 may be thin lines patterned into a mesh. In a case where the heating wires 92 are thin lines patterned into a mesh, as a material to constitute the heating wires 92, for example, at least one member of gold, silver, copper, platinum, aluminum, chromium, molybdenum, nickel, titanium, palladium, indium, tungsten, and an alloy thereof. Further, the bus bars 102 and 104 may be transparent conductive films. In a case were the bus bars 102 and 104 are transparent conductive films, the transparent conductive films may, for example, be a tin-doped indium oxide (ITO) film or a tin oxide film.

The position of arrangement of the sheet-formed heating elements 94 and 96 may be on a surface other than the surface on the automobile exterior side of the glass plate 12, and for example, as shown in the cross sectional view shown in FIG. 14B or 15B, a surface on the automobile interior side of the glass plate 12, a surface on the automobile exterior side of the glass plate 14, or a surface on the automobile interior side of the glass plate 14.

The present invention has been described above, however, the present invention is by no means restricted to the above examples, and various changes and modifications are possible without departing from the intention and the scope of the present invention. Further, the automobile window glass of the present invention is applicable to window glass for railway vehicles and ships, in addition to automobiles.

### REFERENCE SYMBOLS

10: windshield, 12: glass plate, 14: glass plate, 16: interlayer, 18: shielding layer, 20: in-vehicle camera, 22: bus bar, 24: bus bar, 26: conductor, 27A, 27B, 27C, 27D, 27E, 27F: bonding region, 28: information transmitting/receiving region, 30: heating portion, 32: lead portion, 34: lead portion, 36: wiring, 38: battery, 40: wiring, 50: resistor, 52: first wiring, 54: second wiring, 56: terminal, 58: first connector, 60: connecting portion, 62: second connector, 64: first wiring, 66: cable band, 68: harness, 70: first connector, 72: terminal, 74: second wiring, 76: second connector, 80: windshield, 82: surplus wire, 84: camera bracket, 86: mirror base, 90: sheet-formed member, 92: heating wire, 94: sheet-formed heating element, 96: sheet-formed heating element, 98: bus bar, 100: bus bar, 102: bus bar, 104: bus bar

What is claimed is:

1. An automobile window glass configured to be attached to an automobile, which comprises an information communication device configured to be mounted on an automobile, a conductor, and a wiring configured to connect the conductor and a power supply disposed in the automobile,
wherein the conductor has a heating portion capable of heating an information transmitting and/or receiving region at which the information communication device is capable of transmitting/receiving information through the automobile window glass, and
which is configured such that a resistor is provided between the heating portion and the power supply.

2. The automobile window glass according to claim 1, wherein the conductor has a power feeding portion to be electrically connected to the wiring, and a lead portion to electrically connect the heating portion and the power feeding portion, and which is configured such that the resistor is disposed between the power feeding portion and the power supply.

3. The automobile window glass according to claim 2, wherein the wiring has a first wiring and a second wiring,
the first wiring has a terminal to be electrically connected to the power feeding portion at a first end, and a first connector at a second end,
the second wiring has a connecting portion to be electrically connected to the power supply at a first end, and a second connector to be electrically connected to the first connector at a second end, and
the resistor is disposed in at least one of the first connector and the second connector.

4. The automobile window glass according to claim 2, wherein the wiring has a connector to be electrically connected to the power feeding portion at a first end, and a connecting portion to be electrically connected to the power supply at a second end, and
the resistor is disposed in the connector.

5. The automobile window glass according to claim 2, wherein the wiring has a terminal to be electrically connected to the power feeding portion at a first end, and
the resistor is disposed in the terminal.

6. The automobile window glass according to claim 1, wherein the conductor has a power feeding portion to be electrically connected to the wiring, and a lead portion to electrically connect the heating portion and the power feeding portion, and
the resistor is disposed between the heating portion and the power feeding portion.

7. The automobile window glass according to claim 6, wherein the resistor is disposed on a part of the lead portion.

8. The automobile window glass according to claim 1, wherein the conductor is a conductor wire, and the heating portion is a heating wire.

9. The automobile window glass according to claim 2, wherein the lead portion is a lead wire.

10. The automobile window glass according to claim 1, wherein the resistor is a fixed resistor.

11. The automobile window glass according to claim 8, wherein the conductor wire is, when the automobile window glass is attached to an automobile, formed on a surface on the automobile interior side of the automobile window glass.

12. The automobile window glass according to claim 1, wherein the conductor is a sheet-formed heating element having heating wires provided on a sheet-formed member.

13. The automobile window glass according to claim 1, wherein the resistor is connected in series between the heating portion and the power supply.

14. The automobile window glass according to claim 1, wherein the resistor is connected in parallel between the heating portion and the power supply.

15. The automobile window glass according to claim 1, which has a shielding layer formed at the outer periphery of the automobile window glass,
the information transmitting/receiving region is a region at least a part of which is surrounded by the shielding layer, and
the visible light transmittance of the information transmitting/receiving region is 70% or more.

16. The automobile window glass according to claim 1, wherein the automobile window glass is a laminated glass having a first glass plate located on the automobile exterior side when attached to an automobile, a second glass plate located on the automobile interior side, and an interlayer to bond the first glass plate and the second glass plate.
